(19) United States
(12) Patent Application Publication
(10) Pub. No.: US 2008/0095148 A1
(43) Pub. Date: Apr. 24, 2008

(54) Mechanism for automatic global network configuration and switch parameter setting using radius/AAA

(76) Inventor: Ashwin B. Hegde, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/584,102

(22) Filed: Oct. 20, 2006

(51) Int. Cl. H04L 12/50

(52) U.S. Cl. 370/360

(57) ABSTRACT

A method for controlling the ports of the switches in a network that has particular application for a cluster of switches that are controlled by a RADIUS/AAA server. Each switch in the cluster of switches transmits interim accounting messages to the server identifying the data activity on each active port of the switch. The server includes a monitoring entity program that compares the accounting messages with the known configuration records of the ports in the switch to determine whether the ports are operating properly. If a port of a switch in the cluster is not operating properly, the monitoring entity program will send a switch control message to a control entity program on the switch telling the switch what to do with the malfunctioning port, such as shut down the port or open other ports.

### BACKGROUND

A network is a collection of devices, such as servers, work stations, telephones, PDAs, etc., that communicate with other either through hard-wires or wirelessly. In a switched network, a plurality of switches allows many nodes or hosts to be efficiently interconnected where blocks of data, referred to as packets or messages, can be transmitted from a source in the network to a host. A plurality of networks can be interconnected to form an internet.

In one known network, a server uses a RADIUS/authentification authorization accounting (AAA) protocol, well known to those skilled in the art to control the operation of the switches and monitor the data ports of the switches. Each switch in the cluster has a dedicated port that is connected to the RADIUS/AAA server that monitors the ports of the switches. The switches communicate with each other over a layer 2 (L2) protocol, such as a medium access control (MAC) sub-layer. The data packets being transmitted through the switches between the hosts in the network communicate with each other on a layer 3 (L3) data link layer.

When a switch activates one of its data ports, it will send an access and authentification message to the server to get port data configuration parameters. The access message may include a management IP address, and/or a hardware MAC address identifying the port or a connected neighboring switch, and/or a predetermined name or password for that port. This identity information is configured in the server as part of the standard RADIUS/AAA configuration. The password can be plain text or encoded.

If the identity information is valid, the server will send an access accept message back to the switch. If the identity information is not valid, then the server sends an access reject message back indicating that the port cannot be used for transferring data through the switch. The identity information transmitted can be for a set of ports on the switch. If the server accepts the request to activate a port, then the access accept message will include the various configuration parameters of the port, including how much data can be transmitted through the port and other conditions.

Once the port or ports on the switch have been configured by the server, the switch sends an accounting start message to the server indicating the validity of the authentification session. The accounting start message tells the server that the switch will now be transmitting data on the port, which can monitored by the server. At such point that the particular port or ports become inactive on the switch, the switch will send an accounting stop message. The switch also provides a data base of how long the port was active, how much data was sent through the port and what data was sent through the port. Various things could make the port or set of ports of the switch go inactive, such as user intervention, a port being timed out, an adjacent switch going down, etc. During the time that the port or ports are active on the switch, the switch will send out periodic or interim accounting messages indicating how much data has or is propagating through the port (bytes/sec), and what kind of data has been propagated through the port.

Occasionally, one or more of the ports in the switch cluster may have a problem that affects the throughput of data on the L3 layer. For example, two much data may be transmitted through a particular port where the buffers in the switch may be overloaded and data packets may be dropped. Further, data packets may get into a continuous loop where the data packages are continually transmitted back and forth between two or more switches in the cluster. Also, there may not be enough bandwidth on the switch for the data it is processing, also resulting in dropped data packets.

### BRIEF DESCRIPTION OF THE DRAWINGS

FIG. 1 is a plan view of a switching network;

FIG. 2 is a data flow diagram showing the flow of data between a switch and a RADIUS/AAA server in the type of network shown in FIG. 1; and

FIG. 3 is a flow chart diagram showing a process for monitoring the ports of the switches in the switch cluster shown in FIG. 1.

### DETAILED DESCRIPTION OF THE EMBODIMENTS

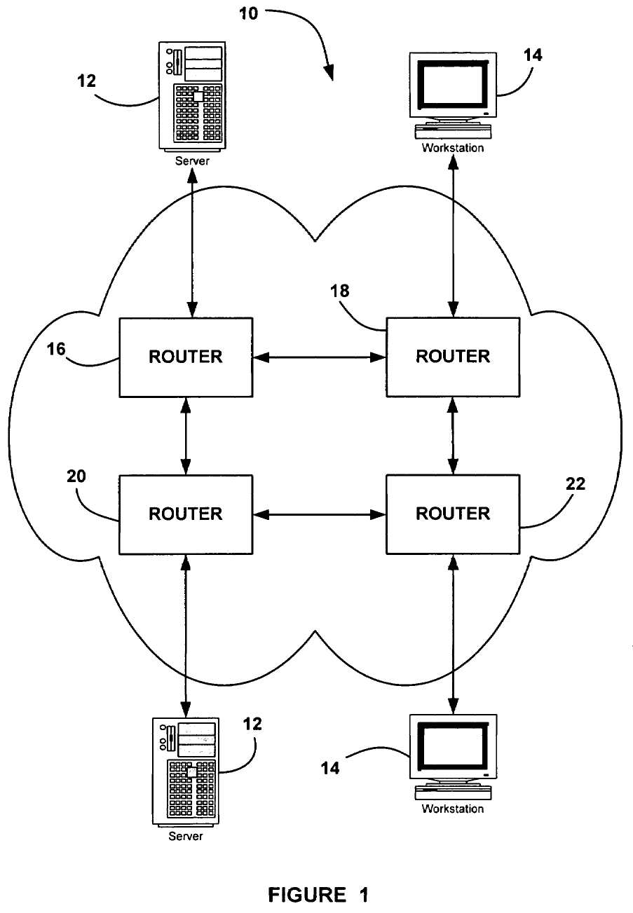

FIG. 1 is a general block diagram of a switched network 10 including servers 12 and work stations 14 interconnected by a cluster of router switches 16, 18, 20 and 22 that illustrates a network. Files are transferred back and forth between the servers 12 and the stations 14. A particular station 14 may request a file from the server 12. The server 12 will send the file to the station 14 through the switches 16, 18, 20 and 22 using an internet protocol (IP) address to identify the station 14.

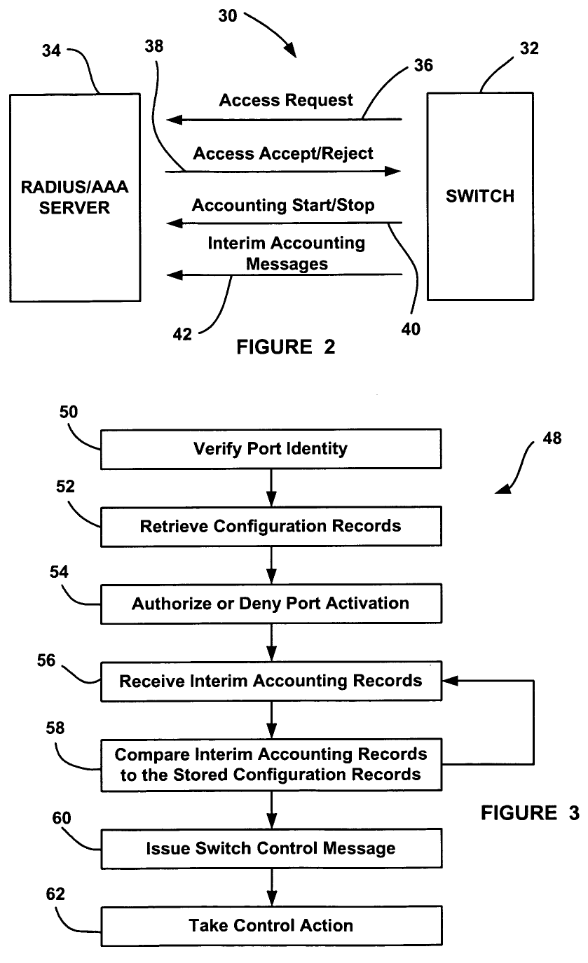

FIG. 2 is a data flow diagram showing message flow between a switch 32 that is part of a switch cluster of the type discussed above and a RADIUS/AAA server 34. In the manner as discussed above, an access and authentification message from the switch 32 to the server 34 to get port data configuration parameters is provided on line 36, the access accept/reject message from the server 34 to the switch 32 is provided on line 38, the accounting start message indicating the validity of the authentification session message from the switch 32 to the server 34 is provided on line 40, and the periodic or interim accounting messages from the switch 32 to the server 34 are provided on line 42.

The discussion below describes a technique for monitoring the data ports of the switches in a switch cluster of a network, and taking certain actions if a port of any of the switches is not operating properly. A monitoring entity program is provided in the RADIUS/AAA server 34 and a control entity program is provided in the switches 16-22. As discussed above, periodic or interim accounting messages are transmitted from the switches 16-22 to the server 34 for documenting the activity on the ports, such as the type of data, amount of data (bytes/sec), etc. The control entity program can gather and add dynamic data to the accounting messages including load on the port, protocols configured on the port and its virtual local area network (VLAN), adjacencies that the port has formed with neighboring switches, etc. Using this information, the monitoring entity program can form a brief topology of the switch cluster.

The periodic accounting messages for a particular port may indicate how much data is currently propagating through the port. The monitoring entity program in the RADIUS/AAA server 34 will look at the stored configuration records to determine how much data should or can be propagating through the port. The monitoring entity program compares the accounting messages from the switches 16-22 to the switch configuration records already stored in the RADIUS/AAA server 34 during the initialization period when the ports were made active in the switches. If the accounting messages do not match the configuration records, then the RADIUS/AAA server 34 will send switch control messages to the control entity program in the switch having the malfunction port to tell the switch how to correct the problem or what action should be taken. In one example, the switch control messages tell the control entity program to turn off a particular port, or turn on one or more other ports to handle increased data flow. The control entity program may turn off a particular port if it is connected to an inactive switch, or if data packets are in a continuous loop with another switch sending the data packets back and forth. In this manner, the server 34 provides quality of service (QOS), port control and load balancing across the switches 16-22.

The following example illustrates a communication between the monitoring entity program and the control entity program. Assume that the accounting records for a switch A indicate that a port on the switch A connected to a switch B, which is in the same cluster as switch A, is overloaded with data. The monitoring entity program can take two separate actions. First, it can tell the control entity program to turn off the overloaded port, or tell the control entity program that it has permission to open more ports to the switch B. The control entity program on the switch A will take the necessary action as indicated by the switch control message. The next set of accounting messages provided by the switch A will inform the server of the latest state of the ports on the switch A.

When the switch 32 and the server 34 go through the authentification process when the port is made active, the return messages from the RADIUS/AAA server 34 identify how many of the ports of the switch are activated. For example, if all of the ports of one switch are connected to the ports of another switch, the RADIUS/AAA server 34 will determine how many of those ports need to be opened to transmit the desirable amount of data therebetween. Additionally, the monitoring entity program can determine that the switch has too many ports open for the current amount of data being propagated therethrough. In that situation, the monitoring entity program can instruct the control entity program to deactivate one or more of the ports.

As mentioned above, the RADIUS/AAA server can also determine whether two or more of the switches are in a continuous loop where the same data packet or packets are being transmitted through the switches 16-22 in a loop manner. If the monitoring entity program in the server 34 does detect such a loop, it can shut off one or more of the ports in the switches 16-22 to prevent the continuous loop, and then provide an indication to the user that the port has been disabled.

At a deeper level, the accounting information sent to the server 34 can be used to determine the correctness of the layer 3 routing configurations, such as open shortest path first (OSPF) protocol and routing information protocol (RIP), with respect to the desired topology, and automatically correct configuration errors. The accounting information can also be used for layer 2 switching configurations. The accounting information can also be used to set up filters based on desired/undesired traffic streams. Further, based on the configuration information, the server 34 can draw out pictorial configurations of the switches 16-22 so that the administrator can make fewer adjustments.

FIG. 3 is a flow chart diagram 48 showing a process for monitoring the ports of a switch in a switched network. The process of the flow chart diagram 48 talks about monitoring a single port of one switch in the switch cluster. However, as discussed above, and will be fully appreciated by those skilled in the art, the process is monitoring all of the active ports of all of the switches in the cluster. The configuration records of the ports are preset or stored, generally manually, in the server, such as values indicating how much traffic can propagate through the port. When a port comes on line, the process verifies the identity of the port, for example through a password or address, at box 50. The process retrieves configuration records for a port at box 52. The process then receives an access or deny request from the switch to authorize activation of a port at box 54. If the identity information is invalid and the request is denied, the process takes a predetermined control action.

If the identity information is valid, the server will send a message back to the switch indicating that the port can be activated. The server will then periodically receive the interim accounting records once the port is activated at box 56. The monitoring entity algorithm will compare the interim accounting records to the stored configuration records for the port at box 58. If the comparison between the accounting records and the configuration records are proper, then the monitoring entity algorithm returns to receiving the interim accounting records at the box 56. If there is a problem between the accounting records and the configuration records at the box 58, then the monitoring entity algorithm issues a switch control message to the control entity algorithm in the switch at box 60. The control entity program will then perform the command in the switch control message at box 62 as discussed above to shut down the port, open other ports, provide an error signal to the user, etc.

The process as described above provides a centralized and automated technique to detect and correct switch cluster configuration problems before the network is impacted. Thus, it will reduce down time of the network due to erroneous or non-optimal switch configurations. Further, every switch in the cluster need not run complicated algorithms to detect loops and perform load distribution. Redundancy mechanisms built into the RADIUS/AAA protocol can provide robustness. This can help reduce switch software size and complications.

The foregoing discussion discloses and describes merely exemplary embodiments. One skilled in the art will readily recognize from such discussion, and from the accompanying drawings and claims, that various changes, modifications or variations can be made therein without departing from the spirit and scope of the embodiments as defined in the following claims.

What is claimed is:

1. A method for controlling a port of a switch in a switch cluster associated with a switching network, said method comprising:
transmitting accounting records from the switch to a server identifying the current data usage of the port;
comparing the accounting records to stored configuration records identifying the proper data usage of the port;
sending a switch control message from the server to the switch identifying a control action if the accounting records do not match the configuration records; and
taking the control action in the switch identified in the switch control message.

2. The method according to claim 1 wherein taking the control action includes shutting down the port.

3. The method according to claim 1 wherein taking the control action includes activating other ports.

4. The method according to claim 1 wherein the switch and the server use a RADIUS/AAA protocol for continuously monitoring the port.

5. The method according to claim 1 further comprising originally authorizing the activation of the port by the server.

6. The method according to claim 1 wherein the switch is an L2/L3 layer switch.

7. The method according to claim 1 wherein the server sends the switch control message if the amount of data being sent through the port is greater than the desirable amount of data the port can accept.

8. The method according to claim 1 wherein transmitting accounting records includes periodically transmitting accounting records.

9. The method according to claim 1 further comprising using the accounting records to determine the correctness of layer 3 routing and layer 2 switching configurations.

10. A method for controlling a port of a switch in a switch cluster associated with a switching network, said method comprising:
authorizing the port to be activated by a server running a RADIUS/AAA protocol;
storing configuration records in the server identifying the desired configuration and data usage of the port;
periodically transmitting accounting records from the switch to the server identifying the current data usage of the port;
comparing the accounting records to the stored configuration records;
sending a switch control message from the server to the switch identifying a control action if the accounting records do not match the configuration records; and
taking the control action in the switch identified in the switch control message.

11. The method according to claim 10 wherein taking the control action includes shutting down the port.

12. The method according to claim 10 wherein taking the control action includes activating other ports.

13. The method according to claim 10 wherein the server sends the switch control message if the amount of data being sent through the port is greater than the desirable amount of data the port can accept.

14. The method according to claim 10 further comprising using the accounting records to determine the correctness of layer 3 routing and layer 2 switching configurations.

15. A network comprising:
a server running a RADIUS/AAA protocol and including a control entity program; and
a plurality of switches running the RADIUS/AAA protocol, each switch including a plurality of ports and a monitoring entity program, said server storing configuration records identifying the desired configuration and data usage of the ports, each switch transmitting accounting records from the switch to the server identifying the current data usage of the ports, said control entity program comparing the accounting records to the stored configuration records, said server sending a switch control message to the switch identifying a control action if the accounting records do not match the configuration records, and said monitoring entity program taking the control action in the switch identified in the switch control message.

16. The network according to claim 15 wherein the control action includes shutting down the port.

17. The network according to claim 15 wherein the control action includes activating other ports.

18. The network according to claim 15 wherein the switches are L2/L3 layer switches.

19. The network according to claim 15 wherein the server sends the switch control message if the amount of data being sent through the port is greater than the desirable amount of data the port can accept.

20. The network according to claim 15 wherein the server uses the accounting records to determine the correctness of layer 3 routing and layer 2 switching configurations.
